(19) United States
(12) Patent Application Publication
(10) Pub. No.: US 2003/0208570 A1
(43) Pub. Date: Nov. 6, 2003

(54) Method and apparatus for multi-modal document retrieval in the computer network

(76) Inventor: Eugene Lapidous, Saratoga, CA (US)

Correspondence Address: Marina Portnova, BLAKELY, SOKOLOFF, TAYLOR & ZAFMAN LLP, 7th Floor, 12400 Wilshire Boulevard, Los Angeles, CA, 90025, US

(21) Appl. No.: 09/785,967

(22) Filed: Feb. 16, 2001

(51) Int. Cl. G06F 15/177

(52) U.S. Cl. 709/222; 709/227

(57) ABSTRACT

In one embodiment, a method for retrieving documents from a computer network includes receiving an indication of a document selection performed by a user and, upon receiving this indication, displaying to the user a list of available data exchange modes. The document selection identifies a desired file reference that is contained within a document displayed to the user. The method further includes determining a data exchange mode that the user chose specifically for the desired file reference and ensuring that a request to retrieve data associated with the desired file reference from a server conforms to the data exchange mode chosen by the user. In one embodiment, the request to retrieve data is directed to a network server storing the data. Alternatively, the request to retrieve data is directed to a proxy server which modifies the request in accordance with the data exchange mode chosen by the user.

### FIELD OF THE INVENTION

The present invention relates to retrieving documents from a server in a computer network. In particular, it relates to a method and apparatus for multi-modal document retrieval in a computer network.

### BACKGROUND OF THE INVENTION

Proliferation of the Internet and the World Wide Web resulted in a large increase of the number of hypertext documents stored in a public network, providing a computer user with access to vast amounts of information. However, the user has typically only limited control over the important parameters of data exchange occurring during document retrieval.

One important parameter of data exchange is the amount of user-specific information sent with a document request to a document server. Usually, such information is sent in the form of an identifier, also known as cookie, previously placed by the document server on the user's hard drive. Sending cookies may be beneficial to the user. For instance, the use of cookies may enable fast authentication, allow access to customized content, and provide relevant on-line advertising. However, accumulation of such user-specific information, especially when done without the user consent, may result in violation of the user's privacy. For example, information about the user's browsing history can be connected with the physical identity of the user and then used to send unsolicited messages to the user or even affect risk factors of insurance and credit rates computed for the user.

Another important parameter of the data exchange is a waiting time required for retrieving a requested document. This waiting time may vary widely from document to document. The user may want to control the waiting time by having an option of requesting a short version of the content, especially if the usefulness of the content is not known in advance (e.g., a document found by the search engine in response to a broad query, or content referenced by the advertisement banner).

One known method of the user control over the data exchange mode consists of changing user preferences or configuration parameters before a document is selected for retrieval. This may be accomplished by changing configuration parameters of an Internet browser to control the amount of user-specific data and the size of retrieved documents. For instance, an Internet Explorer browser, developed by Microsoft®, can be configured to avoid sending cookies with document requests or requesting image files associated with retrieved documents. In addition, an Internet browser may support varied security and content filtering levels for different content servers accessed during the same session (e.g., Internet Explorer allows to specify a list of trusted web sites that can be accessed with a lower level of privacy protection). However, changing default settings of the browser to specify the data exchange mode modifies the exchange mode for all subsequent document retrievals until the browser is reconfigured. That is, this method is ineffective if the user does not know in advance which documents may require a different data exchange mode. For instance, after receiving a list of documents from the search engine, the user may want to retrieve full versions of relevant documents and abbreviated versions of the documents whose relevance is questionable. Similarly, the user may want to withhold personal information when accessing a link connected to the advertisement, but share it with the provider of the content referenced in the body of the document. If the browser is reconfigured every time a new request for information is submitted, the number of actions needed to activate retrieval of each document (e.g., moving cursor, clicking, etc.) would be significantly increased. One additional disadvantage of this method is that the user control over the data exchange mode is limited to the options offered by the browser. For instance, some Internet browsers have settings that allow rejection of new cookies, but do not have settings that prohibit sending of already existing cookies with new document requests to the same server. Thus, this method cannot be efficiently used for dynamic adjustments of the data exchange mode.

Another existing method of the user control over the data exchange mode uses an intermediary program which may modify requests and/or responses using, for instance, support media type transformation, protocol reduction, or anonymity filtering. For example, an anonymizing proxy server, such as Anonymizer®, protects the user's identity from the content server by modifying the fields “cookie”, “referrer” and “from” in the user request that is sent in accordance with the HTTP protocol. A transcoding proxy server, such as a transcoding proxy developed by IBM, reduces the amount of data sent to the user by compressing images, changing their size or format. The user can direct document retrieval through the proxy by specifying the address of the proxy as a browser configuration parameter. The user may also specify a list of known locations that can be accessed while bypassing proxy. Using this method, the user can select a proxy that is best suited for his or her needs. However, switching to a different proxy through the browser re-configuration process can be as inconvenient for dynamic adjustment of the data exchange mode as changing default security or content reduction settings in the browser. Using the same proxy for multiple documents may also increase the download time and decrease connection reliability by introducing potential bottleneck in the document retrieval process.

In one other existing method of controlling the data exchange mode, a proxy server may be specified for each document, without affecting a default browser configuration. In this method, the proxy server is addressed as a content provider, and the location of the requested document is included as additional information. For instance, the user may anonymously access the YAHOO!® web site, without changing the browser configuration, by specifying in the address field of the browser the URL of the proxy server followed by the URL of the YAHOO!® web site. The proxy server receives a user request, passes it to a document server (e.g., YAHOO!®), and then transfers a response issued by the document server to the user computer. One disadvantage of this method is a large cost of modifying a data exchange mode. That is, this method requires that the user type a text string for a document that could be otherwise requested by a single click on the link, effectively abandoning use of hyperlinks in the non-default modes.

The amount of retrieved data can also be controlled using options offered by a content provider. For instance, the content provider may display a product description which includes links to the list of main features and to the complete specification. These links may refer to content optimized for delivery through a low-bandwidth connection and to content optimized for delivery through a high-bandwidth connection. The user may then select an appropriate section in accordance with the required connection. However, this method, while providing an easy selection mechanism, limits the user control of the data exchange mode to the options offered by the content provider, whose priorities may be different from the user's priorities. In addition, reliance on the content provider for privacy protection may not be desirable.

Lack of a convenient way for the user to control the data exchange mode during document retrieval negatively affects users, as well as content providers. If default security settings of the user's browser do not allow sending user-specific information with a document request, a content provider is limited in its ability to customize revenue-producing offerings. Alternatively, if a default security level is low and content reduction is not enabled, the user may be reluctant to retrieve documents of uncertain relevancy. Thus, a convenient mechanism is needed that will allow the user to efficiently control the data exchange mode during retrieval of documents from the computer network.

### SUMMARY OF THE INVENTION

The present invention relates to various aspects for retrieving documents in a computer network. In one aspect of the present invention, an exemplary method of the invention includes receiving an indication of a document selection performed by a user and, upon receiving this indication, displaying to the user a list of available data exchange modes. The document selection identifies a desired file reference that is contained within a document displayed to the user. Further, the exemplary method includes determining a data exchange mode that the user chose specifically for the desired file reference and ensuring that a request to retrieve data associated with the desired file reference from a server conforms to the data exchange mode chosen by the user.

According to another aspect of the present invention, an exemplary method includes receiving an indication of a data exchange mode chosen by a user for a desired file reference and utilizing the data exchange mode to determine whether the data associated with the desired file reference should be retrieved directly from a destination network server that stores this data. If a determination is made that the data should not be retrieved directly from the destination server, the request for this data is directed to a proxy server which modifies the request in accordance with the data exchange mode chosen by the user.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a document retrieval system;

FIG. 2 illustrates an exemplary user interface facilitating a selection of a data exchange mode via a configuration panel of a browser, according to a prior art embodiment;

FIGS. 3A-3C and 4A-4C illustrate exemplary user interfaces facilitating a selection of a data exchange mode, according to various embodiments of the present invention;

FIGS. 5A-5D are block diagrams illustrating a process of exchanging data using four exemplary modes of data exchange, according to one embodiment of the present invention;

FIGS. 6A-6B are block diagrams illustrating data exchange involving a re-direction of a retrieval request to another location;

FIGS. 7A and 7B illustrate data filtering operations performed by a proxy server, according to one embodiment of the present invention;

FIG. 8 is a block diagram illustrating a process of coordinating destination computers for a document retrieval request based on a data exchange mode, according to one embodiment of the present invention.;

FIG. 9 is a block diagram illustrating a process of passing document retrieval requests through more than one proxy server depending on a selected data exchange mode, according to one embodiment of the present invention;

FIGS. 10A-10B are flow diagrams of a method for retrieving a document in a computer network, according to one embodiment of the present invention;

FIG. 11 is a flow diagram of a method for providing a document-specific selection of a data exchange mode, according to one embodiment of the present invention;

FIG. 12 is a flow diagram of a method for varying destination computers depending on data exchange modes of document retrieval requests, according to one embodiment of the present invention; and

FIG. 13 is a block diagram of one embodiment of a computer system.

### DETAILED DESCRIPTION OF THE INVENTION

Methods and systems for retrieving documents in a computer network are described. In the following description, numerous details are set forth, such as distances between components, types of molding, etc. In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. Instructions are executable using one or more processing devices (e.g., processors, central processing units, etc.).

The algorithms and displays presented herein are not inherently related to any particular computer or other apparatus. Various general purpose machines may be used with programs in accordance with the teachings herein, or it may prove convenient to construct more specialized apparatus to perform the required method steps. The required structure for a variety of these machines will appear from the description below. In addition, the present invention is not described with reference to any particular programming language. It will be appreciated that a variety of programming languages may be used to implement the teachings of the invention as described herein.

### Document Retrieval System

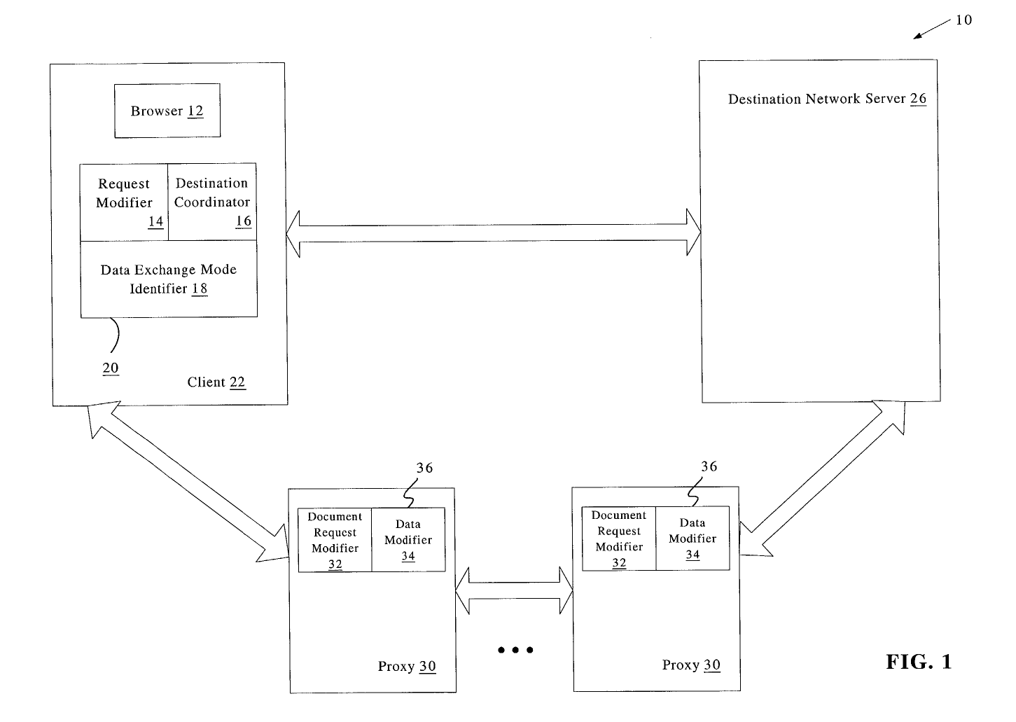

FIG. 1 is a block diagram of one embodiment of a system 22 in which a client computer (referred to herein as “client”) 22 requests data from a destination network server 26. Client 22 is coupled to network server 26 via a public network (e.g., Internet). In one embodiment client 22 is also coupled to one or more proxy servers 30 via a public network or an internal network (e.g., LAN, Intranet, etc.)

Client 22 includes a web browser 12. Web browser 12 may be any browser known in the art such as, for example, Internet Explorer, Netscape browser, etc. When a user of client 22 requests data from network server 26 (e.g., by entering a URL of network server 26, or activating a link, a graphical object, or other file reference contained within a document displayed to the user), browser 12 issues a request to retrieve this data from network server 26. As described above, it would be beneficial for the user to have control over an exchange mode of data requested by the user. For instance, the user may want to control the amount of user-specific information sent with the request to protect his or her privacy. Specifically, in accordance with Hypertext Transfer Protocol (HTTP), the request may contain user-specific information in such request-header fields as, for example, “cookie”, “referrer” and “from”. The field “cookie” contains an identifier which was placed on client 22 when client 22 accessed data stored on network server 26 during one of the previous sessions. The field “referrer” includes the address of the parent document that contains a link (or any other file reference) that is currently of interest to the user. Accordingly, the field “referrer” may identify the user's browsing history with respect to a server other than network server 26. The field “from” contains the user's e-mail address, thereby directly identifying the user to network server 26. In addition, the user may want to control the size of data retrieved from network server 26 in response to the user request (e.g., the user may not want to see any images embedded in this data), the format of this data (e.g., the user may prefer that the data be displayed with annotations), and other similar characteristics of the data.

The presents invention provides a mechanism that allows the user to vary the data exchange mode for each file reference contained in the parent document, thereby controlling the amount of personal information exposed to network server 26 and the size and format of data retrieved from network server 26.

In one embodiment, client software 20 includes a data exchange mode identifier 18 to receive an indication of a document selection performed by the user. The indication of the user selection may be received when, for example, the user selects an area on the screen that is associated with a certain file reference. File references referred to herein may include references to documents and resources on public and private networks and may be in the form of links, graphical objects, textual URLs, etc.

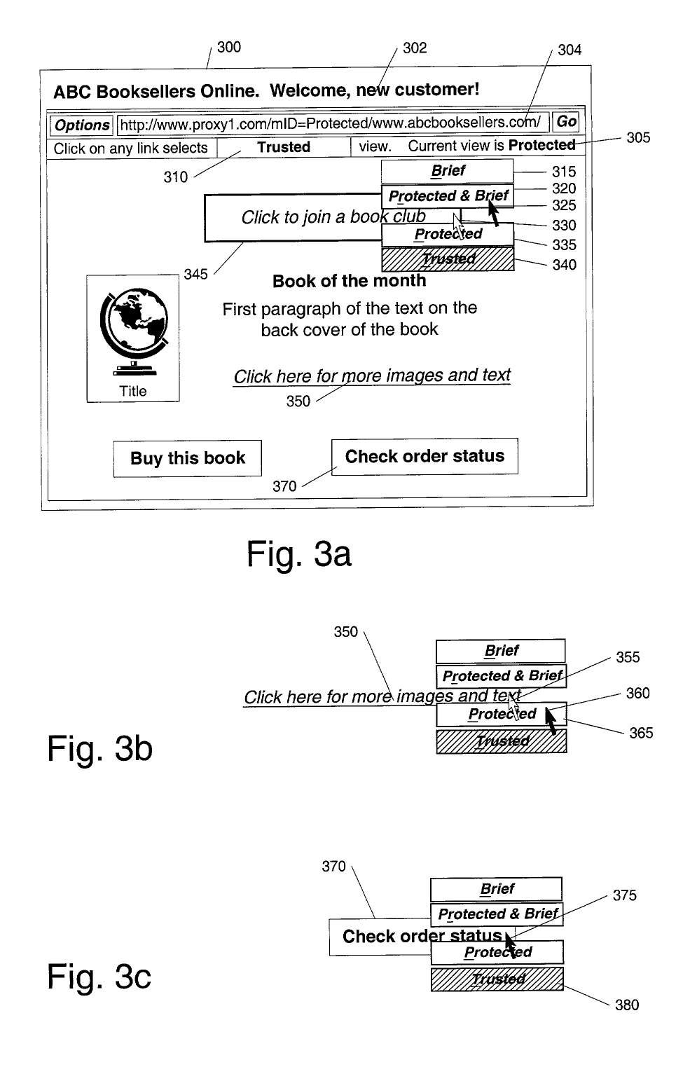

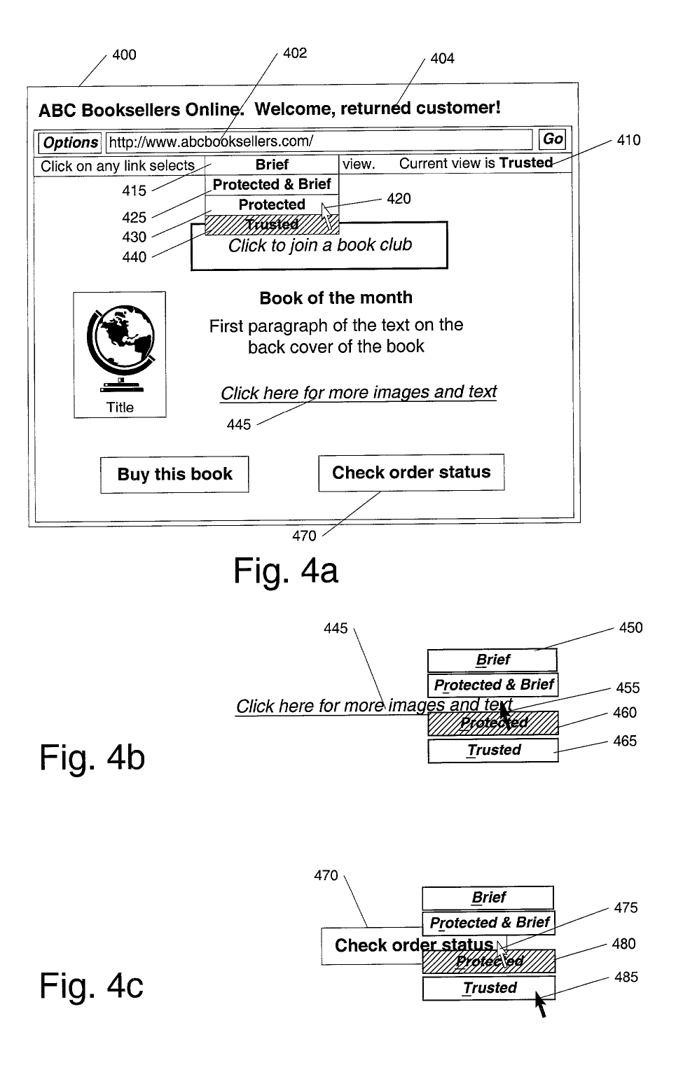

Upon receiving the indication of the user selection, data exchange mode identifier 18 presents a user interface which communicates to the user a list of available data exchange modes. Exemplary user interfaces will be described in greater detail below in conjunction with FIGS. 3A-3C and 4A-4C. In one embodiment, the user is allowed to increase or decrease the number of available data exchange modes during the installation of software 20 or at any other time.

The available data exchange modes may, for example, include a trusted mode which allows sending user-specific information to network server 26, a protected mode which limits that amount of user-specific information sent to network server 26, a brief mode which limits the size of data received from network server 26, and various combinations and variations of the above data exchange modes. In addition, it should be noted that a wide variety of data exchange modes other than those described above can be used with the present invention without loss of generality. For instance, such data exchange modes may result in retrieving documents augmented with annotations or sets of related links, provide fine distinctions in the extent of privacy protection and document reduction, etc.

Further, data exchange mode identifier 18 may determine a data exchange mode specifically chosen by the user for the desired file reference. In one embodiment, this determination is made upon detecting a predefined sequence of actions performed by the user while the list of available file references is being displayed on the screen. The predefined sequence of actions includes the user interaction with a cursor control device and/or a keyboard key. In an alternate embodiment, the determination is made considering a preferred data exchange mode designated by the user prior to selecting a particular file reference. Specifically, the preferred data exchange mode will be presumed unless the user performs an action sequence indicating the selection of a different exchange mode. That is, if the user selects the preferred data exchange mode for a particular file reference, the user can simply activate this file reference (e.g., by clicking on the link), without performing any addition manipulation with the cursor control device or keyboard. Otherwise, for any other data exchange mode, the user is expected to perform a predefined action sequence described above. Accordingly, the number of situations requiring the user to perform additional actions when selecting a data exchange mode is reduced.

Software 20 also includes a request modifier 14 to ensure that a request to retrieve data associated with the selected file reference from network server 26 conforms to the data exchange mode chosen by the user. In one embodiment, request modifier 14 updates configuration parameters of web browser 12 to match the requirements incorporated in the chosen data exchange mode. As a result, the request issued by web browser 12 will conform to the data exchange mode. When the document retrieval action completes, request modifier 14 restores the configuration parameters of web browser 12 to their prior state. Alternatively, request modifier 14 does not interfere with the configuration parameters of web browser 12 but intercepts the request issued by web browser 12 and modifies this request in accordance with the data exchange mode chosen by the user.

In an alternative embodiment of the present invention, the request for data may not be sent directly to network server 26. Depending on the data exchange mode selected by the user, the request may be sent either to a proxy 30 or network server 26. In this embodiment, software 20 includes a destination coordinator 16 to determine whether the data requested by the user should be retrieved directly from network server 26 and to direct a request for this data to an appropriate destination depending on this determination. In one embodiment, the request is sent to proxy 30 rather than to network server 26 if the selected data exchange mode requires modifying either the request or the data retrieved from network server 26. In one embodiment, proxy 30 includes software 36 containing a request modifier 32 and/or a data modifier 34. In one embodiment, the request sent to proxy 30 includes an identifier of the data exchange mode. Based on this identifier, request modifier 32 modifies the request issued by client 22 and/or data modifier 34 modifies the data retrieved from network server 26. Alternatively, proxy 30 has no knowledge of the data exchange mode (i.e., the identifier of the data exchange mode is not included in the request) and simply performs a set of predetermined operations such as, for example, removing the user-specific information from the request, reducing the size of a document retrieved from network server 26, removing annotations from the document, etc.).

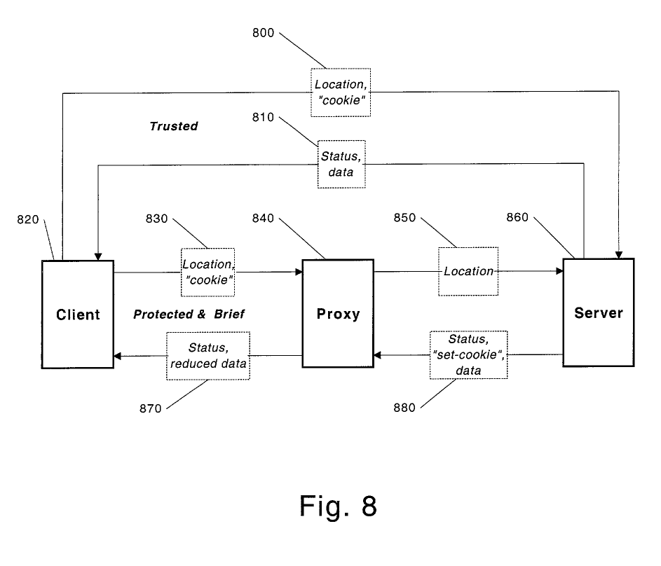

In a multi-user environment, when a single proxy is used to receive all document requests, a bottleneck problem may occur, thereby decreasing the reliability of the document retrieval operations. In addition, the use of a single proxy for all document requests may present a security risk by accumulating the complete browsing history of the user on one computer. One embodiment of the present invention addresses the above problems by using proxy 30 to modify document requests and document data when the selected data exchange mode requires any of these modifications, while sending document requests directly to the destination server 26 if the selected data exchange mode does not require request or data modification outside of client 22. One embodiment of using different destinations for requests issued by the client computer is described in greater detail below in conjunction with FIG. 8.

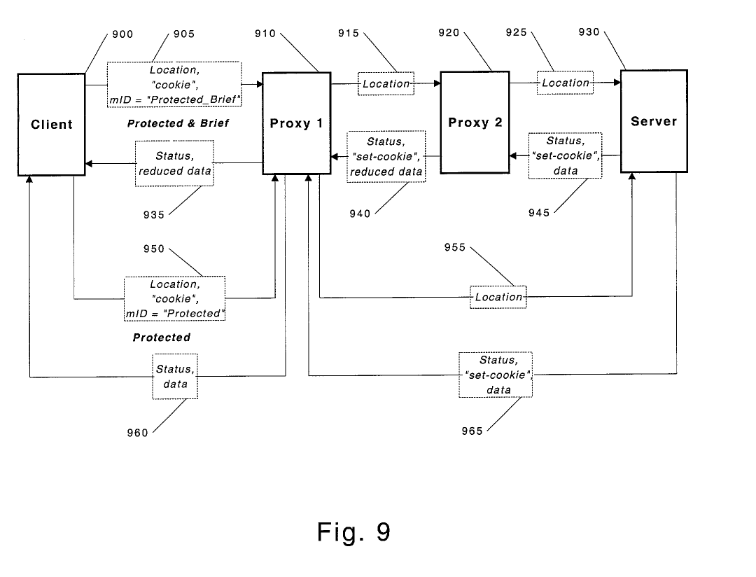

Another embodiment of the present invention addresses the above problems by using a chain of proxies 30. That is, the request and the retrieved data are passed through a chain of proxies 30 to perform various modifications required by the data exchange mode. For instance, if the user selects a data exchange mode requiring to maintain a high level of privacy, as well as to reduce the size of the retrieved document, the request may be directed to a first proxy for removing the user-specific information and then to a second server which controls the size of the retrieved data. The use of one or more proxies when processing the user request for information stored on network server 26 is described in greater detail below in conjunction with FIG. 9.

### Document-Specific Selection of Data Exchange Mode

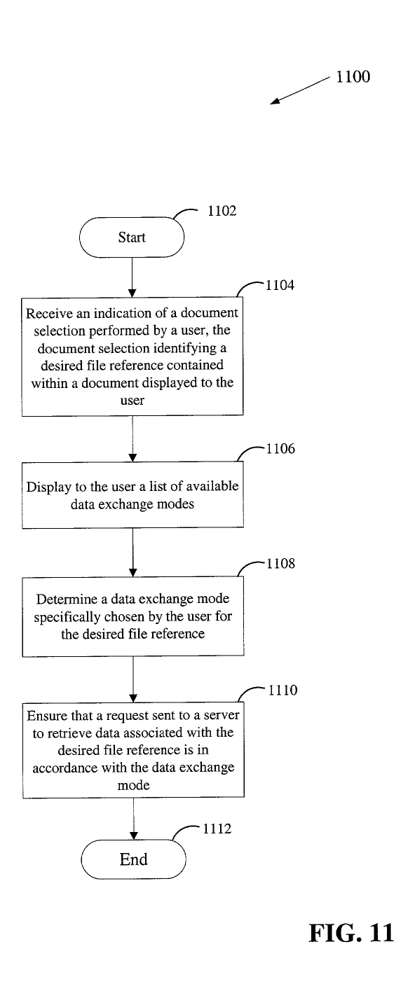

FIG. 11 is a flow diagram of a method 1100 for providing a document-specific selection of a data exchange mode, according to one embodiment of the present invention. Method 1100 begins with receiving an indication of a document selection performed by a user. The document selection identifies a desired file reference which is contained within a document currently displayed to the user.

At processing block 1106, a list of available data exchange modes is displayed to the user upon receiving the indication of the document selection. The user can then select a data exchange mode for the desired file reference. As described above, the selected data exchange mode is associated only with this file reference and has no effect on subsequent document retrieval requests of the user. The data exchange mode may control the amount of user-specific information sent with a document request, the size and format of data retrieved from the server, or other similar characteristics.

At processing block 1108, method 1100 determines a data exchange mode chosen by the user for the desired file reference. As described above, this determination is made based on a predefined sequence of actions performed by the user during the selection of the data exchange mode. In one embodiment that supports a preferred data exchange mode, the user does not need to perform any addition action if the user chooses the preferred data exchange mode for the desired file reference.

At processing block 1110, method 1100 ensures that a request to retrieve data from the server is in accordance with the data exchange mode selected by the user. In one embodiment, this is achieved by updating configuration parameters of the browser to incorporate the requirements of the data exchange mode, thereby forcing the browser to issue a request conforming to the data exchange mode. Alternatively, the configuration parameters of the browser remain unchanged but the request issued by the browser is intercepted and modified to conform to the data exchange mode.

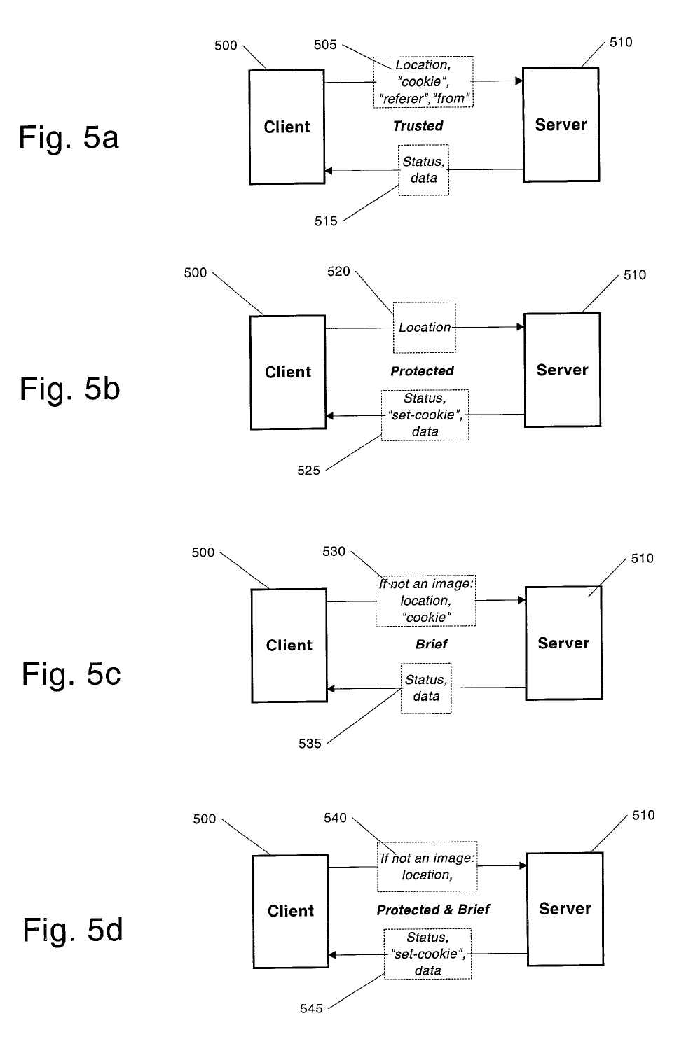

Data exchange operations will now be described in greater detail, according to one embodiment of the present invention. FIGS. 5A-5D are block diagrams illustrating a process of exchanging data between a client 500 and a server 510 using four exemplary modes of data exchange, according to one embodiment of the present invention. The four exemplary modes are referred to as “Trusted”, “Protected”, “Brief”, and “Protected & Brief”.

If the “Trusted” data exchange mode is selected, as shown on FIG. 5A, data 505 containing a request to retrieve a document from a known location is sent from client 500 to server 510. As shown, this data, which is sent in accordance with Hypertext Transfer Protocol (HTTP), contains user-specific information in the request-header fields “cookie”, “referrer” and “from”. The information stored in these fields is described in greater detail above. After receiving document request 605 with the user-specific information, server 510 responds by sending data 515 containing status of the request being processed and, if processing is successful, the requested document. Alternatively, depending on the application settings, some user-specific information may not be allowed to be sent to server 510 in the “Trusted” mode (e.g., the information contained in the field “cookie” will be sent to the server but not the information contained in fields “referrer” and “from”).

If the “Protected” data exchange mode is selected, as shown on FIG. 5B, the user-specific information is not included in the request, making the user anonymous to server 510. In response, server 510 returns data 525 containing the status of the request being processed, the document data if processing is successful and a request to store cookie sent in the field “set-cookie”. Alternatively, depending on the application settings, some user-specific information may be sent to the server even in the “Protected” mode, for instance, data in the “referrer” field. The difference between the “Trusted” and “Protected” modes is in the amount of the user-specific information sent with the document request, i.e., at least some user-specific information sent with the document request in the “Trusted” mode is not allowed to be sent in the “Protected” mode.

The “Trusted” and “Brief” data exchange modes differ in the amount of document data received by client 500 in response to a document request, thereby providing the user with a choice of receiving a larger version of the document and spending more time to complete the data exchange versus receiving a shorter version of the document and spending less time to complete the data exchange. Referring to FIG. 5C, illustrating the “Brief” data exchange mode, not all data files associated with the selected reference are requested from server 510. For instance, when a document data file received in response to a document request contains references to other documents (e.g., embedded images), data files identified as images are not requested from server 510. That is, request 530 is sent to server 510 only if the requested document is not an image. Server 510 returns document data 535 for all successfully processed requests, but because the number of such requests is smaller than in the “Trusted” mode, the retrieval of the document is completed faster.

FIG. 5D illustrates data retrieval in the “Protected & Brief” data exchange mode, where a document request 540 does not contain any user-specific information and is sent only if the requested document is not an image. Server response 545 includes a request to store cookie, which may be ignored by the client.

As illustrated, data exchange modes may differ from each other in both the amount of user-specific information sent from the user's computer and the size of received document data. Additionally, other data exchange modes may be used to vary the format of the received document data (e.g., requesting data with or without annotations).

As described above, each data exchange mode is selected after indicating on the screen an area associated with a desired file reference. In one embodiment, the selection of such data exchange mode is valid only for one document request (issued for the desired file reference) and does not affect subsequently retrieved documents. Alternatively, the selection of the data exchange mode occurring after the document selection may remain valid for subsequent one or more document retrieval requests that are issued without further user input. For instance, as described above in relation to FIGS. 5C and 5D, a document retrieval request may result in requesting multiple image files embedded in the parent document. In this example, if the selected data exchange mode is “Trusted”, then the user-specific information is sent with each request for an image file. Similarly, if the selected data exchange mode is “Protected”, then the user-specific information is not sent with any request for an image file.

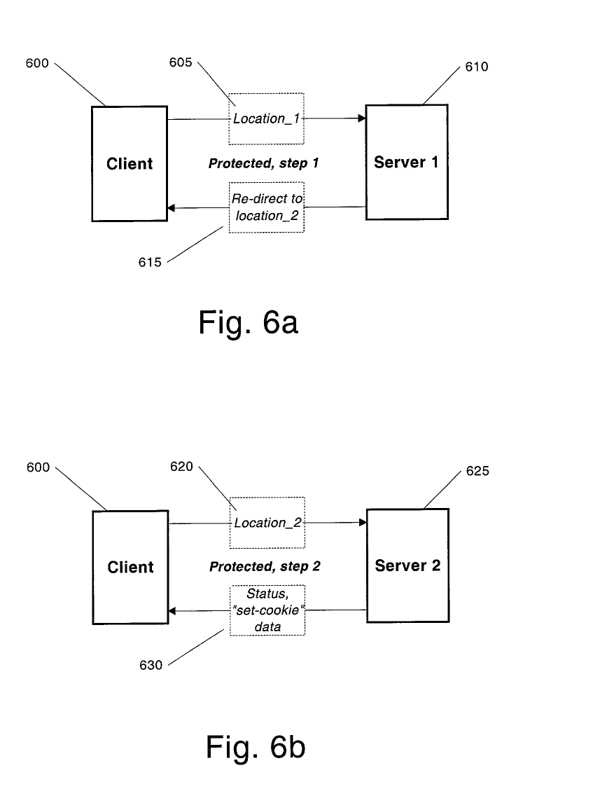

Another example where the same data exchange mode remains valid for multiple document requests is shown on FIGS. 6A and 6B. In this example, after a file reference is selected, the user chooses the “Protected” mode, which results in the update of the configuration parameters of the browser. Further, client 600 sends request 605 to retrieve a document from Location_1 on a first server 610. Instead of sending document data, server 610 responds with a re-direction message 615, informing client 600 that the location of the requested document has changed to Location_2. After receiving message 615, client 600 issues a second request 620 to retrieve the requested document from Location_2 on a second server 625. This request is sent automatically, without further user input. During this request, the state of the configuration parameters of the browser remains the same. Accordingly, no cookie is sent with request 620. That is, the user who selected the “Protected” data exchange mode remains anonymous to both servers involved in the retrieval of the same document. Similarly, if the user selects the “Trusted” data exchange mode, any of the two servers may receive cookie stored on client 600. Subsequently, when response 630 with document data is received by client computer 600, the configuration parameters of the browser are restored to their previous state.

In one embodiment, a selection of a data exchange mode for a current document request is achieved by changing one or more configuration parameters of the browser after a new data exchange mode is selected, and restoring them to their previous state after the requests for all document files are issued. Thus, the parameter values of the data exchange mode selected for the current file reference are not affected by either the parameter values used during the retrieval of the previous document or the permanent values set by the user before the selection of the file reference.

In another embodiment, the permanent data exchange parameters set before the selection of the file reference affect the data exchange. For example, if the user sets the configuration parameter “Report referring document” in the browser configuration panel, the document request will include the “referrer” field in the “Trusted” or “Protected” mode. In particular, if the box corresponding to this parameter is checked in the browser configuration panel, the client computer will send the “referrer” and “cookie” fields with document request in the “Trusted” mode, or only the “referrer” field with the document request in the “Protected” mode. If the box corresponding to this parameter is unchecked in the configuration panel, the client computer will send the “cookie” field with document request in the “Trusted” mode, or no user-specific information with the document request in the “Protected” mode.

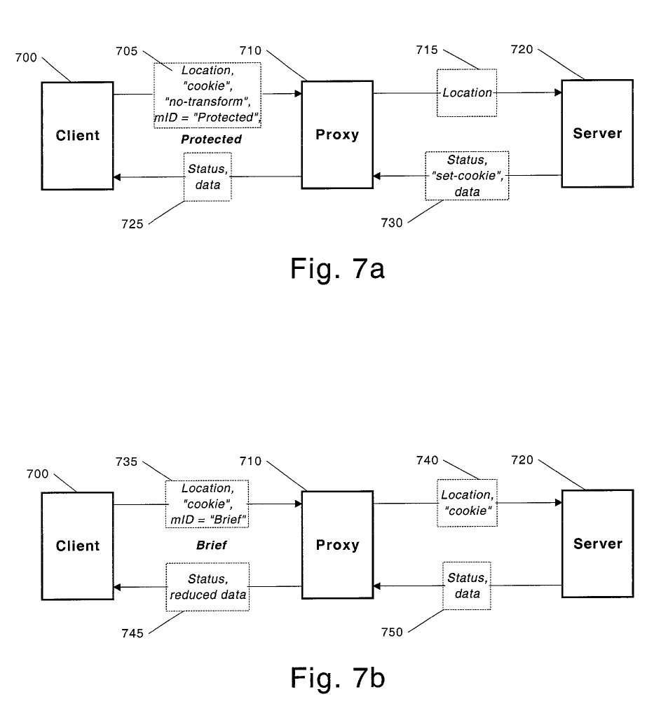

The use of configuration parameters of the web browser to create the document request that conforms to the selected data exchange mode is limited to the configuration choices and may not provide the required level of security or document size reduction. For instance, the browser may allow or forbid the storage of new cookies, but have no option to prevent previously stored cookies from being reported. In one embodiment of the present invention, the temporary modification of the data exchange mode is achieved by modifying functionality of a proxy server, without changing configuration parameters of the browser. FIGS. 7A and 7B illustrate data filtering operations performed by a proxy server, according to one embodiment of the present invention.

Referring to FIG. 7A, an example of the data exchange in the “Protected” mode is illustrated. After a file reference and a data exchange mode are selected by the user, client computer 700 sends a document retrieval request 705 to a proxy server 710. In addition to document location and cookie information, request 705 contains an identifier of the selected mode of data exchange (mID=“Protected”). Proxy server 710 compares identifier of the selected data exchange mode with a list of predefined values, and after the identifier is recognized, performs a corresponding filtering of the data stream. In this case, it removes cookie from the request-header and passes document request 715 to server 720. Server 720 sends a response 730 to proxy 710 with document data and the “set-cookie” field which is included in response 730 because server 720 did not receive a cookie with a document request. Proxy 710, after receiving response 730, processes it in accordance with the data exchange mode identifier which was received with document request 705. In particular, proxy 710 removes the “set-cookie” field from response 730 and sends document data 725 to client 700. In this embodiment, the proxy functionality is controlled by an identifier of the data exchange. In an alternative embodiment, the proxy functionality is controlled by standard directives as defined by the HTTP protocol. In the example shown on FIG. 7A, document request 705 contains a “no-transform” directive. As defined in the HTTP protocol, this directive informs proxy 710 that all document data received from server 720 must be passed to client 700 without any change.

Referring to FIG. 7B, an example of the data exchange in the “Brief” mode is illustrated, where the user wants to retrieve a reduced version of the requested document while not hiding the user-specific information from the document server. Document request 735 sent by client 700 to proxy 710 contains the document location, cookie and an identifier of the selected data exchange mode. Proxy 710 extracts this identifier and passes document request 740 with the “cookie” field to server 720. Server 720 responds by sending document data 750 back to proxy 710. After receiving data 750, proxy 710 processes it according to the stored identifier of the data exchange mode. When the stored identifier corresponds to the “Brief” data exchange mode, proxy 710 performs the document size reduction and sends reduced document data 745 to client 700.

When the data exchange mode “Brief” is selected, some data files received from the server as a result of the document selection may not be reduced in size. For instance, only files containing images embedded in the parent document may be reduced in size. One particular way to perform such reduction may be to decrease the color or spatial resolution of images that have file sizes exceeding a predefined limit while passing smaller images to the client without modification.

### Exemplary User Interfaces Facilitating Selection of Data Exchange Mode

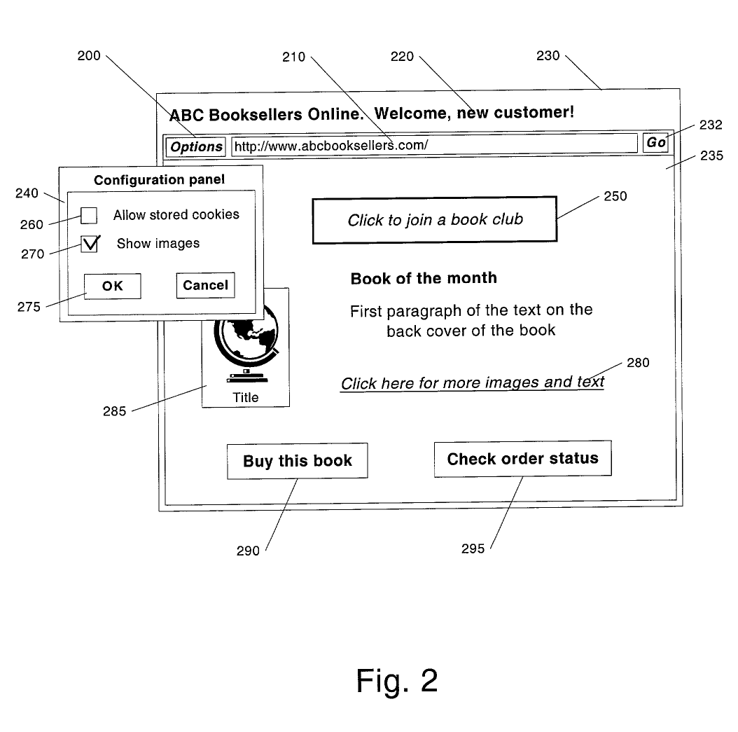

FIG. 2 illustrates an exemplary user interface facilitating a selection of a data exchange mode using a configuration panel of a web browser, as known in the prior art. Window 230 of a sample browser application contains a client region 235 that displays a sample document retrieved from the computer network. This document is a World Wide Web page retrieved from address 210 and having a title 220. The sample document is written in Hypertext Markup Language (HTML) and contains file references (e.g., links) to other documents in the computer network. These links are associated with areas inside client region 235; each link can be selected by moving the cursor into the associated area on the screen and then performing a known action sequence, for instance, pressing and releasing left mouse button. Examples of such areas are an area of the image of the advertising banner 250 that references an HTML document stored on a first network server and an area of the underlined text 280 that references an HTML document stored on a second network server. Other examples of such areas are areas of buttons 290 and 295 that reference a computer program creating an HTML document in response to the user's selection. The document in client region 235 also contains a reference to a data file associated with an image 285. Image 285 is embedded in the HTML document; a request for the retrieval of image 285 is issued with the request to retrieve this HTML document, without additional user input. The type and size of data exchanged between the user's computer and a network server can be controlled by changing configuration parameters of the browser on a configuration panel 240. Configuration panel 240 may be displayed, for instance, when the user selects a button 200 “Options” in the browser window 230. Configuration panel 240 contains checkboxes 260 and 270. Checkbox 260 controls processing of a user-specific identifier (also known as “cookie”) sent by the server together with requested document data. If box 260 is checked, such cookie can be stored on the user's computer and sent to the same server with a subsequent document retrieval request, thereby identifying the user's computer to the server. If box 260 is unchecked, storage of cookies on the user's computer is prohibited, and therefore no cookie is sent during the next document request to the same server, preventing the user's identification. If box 270 is checked, retrieval requests are issued for all image files embedded in the retrieved HTML document, thereby allowing display of embedded images. If box 270 is unchecked, requests for embedded images are not issued; the document is loaded faster but with a lower visual quality. The user selection of the interface elements defining the data exchange mode becomes valid after selecting “OK” button 275. After button 275 is selected, configuration panel 240 becomes hidden. The selected changes remain valid for all subsequent document requests until the next interaction with configuration panel 240. Next document can be requested either by moving cursor into the associated area on the screen and performing a selection action such as a click of the mouse button, or by typing an address of the document in the area 210 and selecting “Go” button 232.

FIGS. 3A-3C illustrate exemplary user interfaces facilitating selections of various data exchange modes after a desired file reference is selected, according to one embodiment of the present invention.

FIG. 3A presents window 300 containing a sample HTML document in the client region 307. Document title 302 indicates that the document server did not identify the user as a prior customer (i.e., it did not receive the user-specific information with a document request). Document location 304 includes the address of a proxy server and an identifier of a data exchange mode.

As indicated in area 305, the data exchange mode used to retrieve the currently displayed document is “Protected”. The data exchange mode that can be selected for the next document by moving cursor to an associated area and clicking mouse button is “Trusted”, as indicated in area 310.

To select a data exchange mode for a file reference associated with an area 345 of the advertising banner, the user moves the cursor to a position 330 in area 345 and presses left mouse button, selecting area 345. After mouse button is pressed, visual indicators of the available data exchange modes are displayed in the vicinity of position 330. These visual indicators are shown as rectangular areas with text: area 315 with text “Brief”, area 320 with text “Protected & Brief”, area 335 with text “Protected”, area 340 with text “Trusted”. Area 340 contains an additional visual indicator—shaded background—signifying that this is a preferred data exchange mode which can be selected by the mouse click in the area 345. The use of the preferred data exchange mode is described in greater detail below in conjunction with FIGS. 4A-4C.

To select the data exchange mode, the user needs to perform one of the available action sequences. A list of exemplary action sequences is as follows:

The “Brief” data exchange mode can be selected by (1) keeping the mouse button pressed, moving the cursor to area 315, and releasing the mouse button; or (2) pressing the “b” key on the keyboard while keeping the mouse button pressed in position 330, releasing the mouse button, and releasing the “b” key;

The “Protected & Brief” data exchange mode can be selected by (1) keeping the mouse button pressed, moving the cursor to area 320, and releasing the mouse button; or (2) pressing the “r” key on the keyboard while keeping the mouse button pressed in the position 330, releasing the mouse button, and releasing the “r” key;

The “Protected” data exchange mode can be selected by keeping the mouse button pressed, moving the cursor to area 335, and releasing the mouse button; or (2) pressing the “p” key on the keyboard while keeping the mouse button pressed in position 330, releasing the mouse button, and releasing the “p” key;

The “Trusted” data exchange mode can be selected by (1) releasing the mouse button while having the cursor in position 330 and performing a mouse click; (2) moving the cursor to area 340 while keeping the mouse button pressed, and releasing the mouse button; or (3) pressing the “t” key on the keyboard while keeping the mouse button pressed in position 330, releasing the mouse button, and releasing the “t” key.

For instance, as shown on FIG. 3A, the user moves the cursor to position 325 in area 320 “Protected & Brief” and releases the mouse button while the cursor is in position 325. It should be noted, however, that action sequences used to select different data exchange modes can vary widely without limiting the scope of the invention. For instance, indicators of available data exchange modes may appear on the screen after the cursor is placed in the area associated with the file reference for a pre-defined time, but before mouse button is pressed, action sequences may comprise different gestures performed by the user in relation to the selected area, for instance, by moving a pen on the surface of the touch screen, etc.

After the action sequence associated with a desired data exchange mode is completed, visual indicators 315, 320, 335 and 340 are removed from the screen and a document retrieval request is issued in the selected data exchange mode, as described above.

FIG. 3B illustrates a selection of the data exchange mode for a file reference associated with an underlined text area 350. First, the user moves the cursor to position 355 in area 350 and presses the left mouse button, selecting area 350. After mouse button is pressed, the visual indicators of the available data exchange modes are displayed in the vicinity of position 355. Similarly to the description provided above with conjunction to FIG. 3A, the user can select the “Protected” data exchange mode by moving the cursor to position 360 inside area 365 of the visual indicator “Protected” while keeping the mouse button pressed, and then releasing the mouse button. After the mouse button is released, the visual indicators of the data exchange modes are removed from the computer screen and the retrieval request for the document associated with area 350 is issued in the “Protected” data exchange mode, as described above.

FIG. 3C illustrates a selection of the data exchange mode for yet one other file reference associated with a button area 370. First, the user moves the cursor to position 375 in area 370 and presses the left mouse button, selecting area 370. After the mouse button is pressed, visual indicators of the available data exchange modes are displayed in the vicinity of position 370, as described above. After pressing the mouse button, the user releases it in the same position 375, performing mouse click. As shown by indicator 310 and by shading of area 380 with text “Trusted”, this action causes selection of the “Trusted” data exchange mode. The selection of the “Trusted” data exchange mode, which is referred to herein as a preferred data exchange mode, is easier to perform than the selection of any other available data exchange mode, as it does not require any additional manipulation with the cursor or a keyboard key before releasing the mouse button. After the mouse button is released, the visual indicators of the data exchange modes are removed from the computer screen and the retrieval request for the document associated with area 370 is issued in the “Trusted” data exchange mode, as described above.

FIGS. 4A-4C are exemplary user interfaces facilitating a selection of a preferred data exchange mode, according to one embodiment of the present invention.

FIG. 4A presents a browser window 400 containing a sample HTML document in the client region 407, retrieved in the “Trusted” data exchange mode. Document location 402 does not include the address of a proxy, indicating that the document is retrieved directly from the server. Document title 404 indicates that the document server did identify the user as a returned customer (i.e., it did receive the user-specific information with a document request). The data exchange mode used to retrieve currently displayed document is indicated in area 410. Window 400 contains indicator 415 of the preferred data exchange mode that can be selected by performing a mouse click in the area associated with the selected document. The area of indicator 415 functions as a pull-down menu, enabling the user selection of a preferred data exchange mode. To change the preferred data exchange mode, the user moves cursor to area 415 and keeps it there for a predefined time (for example, at least for 0.25 second). As a result, a pull-down menu with the list of available preferred data exchange modes appears. This list may contain various data exchange modes and may be the same or smaller than the list of available data exchange modes illustrated on FIGS. 3A-3C. In the example illustrated on FIG. 4A, the selection choices for a preferred data exchange mode include “Brief”, “Protected & Brief”, “Protected” and “Trusted”, associated with corresponding areas 415, 425, 430 and 440. Area 440 has shaded background to identify that it is a currently selected choice. The user can select any of the preferred data exchange modes listed in the pull-down menu by moving cursor to the corresponding area and performing a mouse click. For instance, in order to change the preferred data exchange mode to “Protected”, the user moves the cursor to position 420 in area 430 and clicks the mouse button. After that, the pull-down menu disappears and text “Protected” becomes visible in area 415 instead of text “Trusted”. In addition to selecting any of the entries in the pull-down menu, the user has an option to move the cursor out of the pull-down menu, causing it to disappear without changing the preferred data exchange mode.

FIG. 4B illustrates a selection of a data exchange mode for a file reference associated with area 445 after the “Protected” data exchange mode is selected as preferred, according to one embodiment of the present invention. While in the example shown on FIG. 3A the user has to select the “Protected” data exchange mode by moving the cursor to an area of its visual indicator, in the example shown on FIG. 4B the user selects the same data exchange mode just by moving the cursor to position 455, pressing and releasing the left mouse button. After the mouse button is pressed, the visual indicators of the available data exchange modes are displayed in the vicinity of position 455. The visual indicator “Protected”, associated with area 460, now has a shaded background to indicate that the “Protected” data exchange mode can be selected by a mouse click in area 445. The visual indicator “Trusted”, associated with area 465, does not have the shaded background because the “Trusted” data exchange mode is no longer preferred as it was replaced by the “Protected” data exchange mode. After the “Protected” data exchange mode is selected as preferred, action sequences associated with the “Preferred” and “Trusted” modes are re-assigned, but other action sequences associated with other data exchange modes remain the same. For example, after the mouse button is pressed at location 455, the user can move the cursor to area 450, while keeping the mouse button pressed, and the release the mouse button when the cursor is in the position 452, selecting the “Brief” data exchange mode. Thus, the action sequence required to select the “Brief” data exchange mode remains the same despite the change in the selection of the preferred mode.

The “Protected” data exchange mode can be selected either by performing a simplified action sequence (i.e., a mouse click) or an action sequence described in conjunction with FIGS. 3A-3C, that includes moving the cursor to the area of its visual indicator.

FIG. 4C illustrates a selection of a data exchange mode for a file reference associated with area of button 470 after the “Protected” data exchange mode is selected as preferred. Because the “Trusted” data exchange mode is no longer preferred, it can be selected by moving the cursor to position 475 in area 470 and pressing the left mouse button, selecting area 470. After the mouse button is pressed, visual indicators of the available data exchange modes are displayed in the vicinity of position 475. The user can then move the cursor to area 485 and release the mouse button.

### Varying Destination Computers Depending on Data Exchange Mode

If a single proxy server is used to receive all document requests, a bottleneck problem may occur, resulting in a decreased reliability of document retrieval operations in a multi-user environment. In addition, sending all user requests through the same proxy server may present a security risk by allowing a third party to collect a complete browsing history of the user.

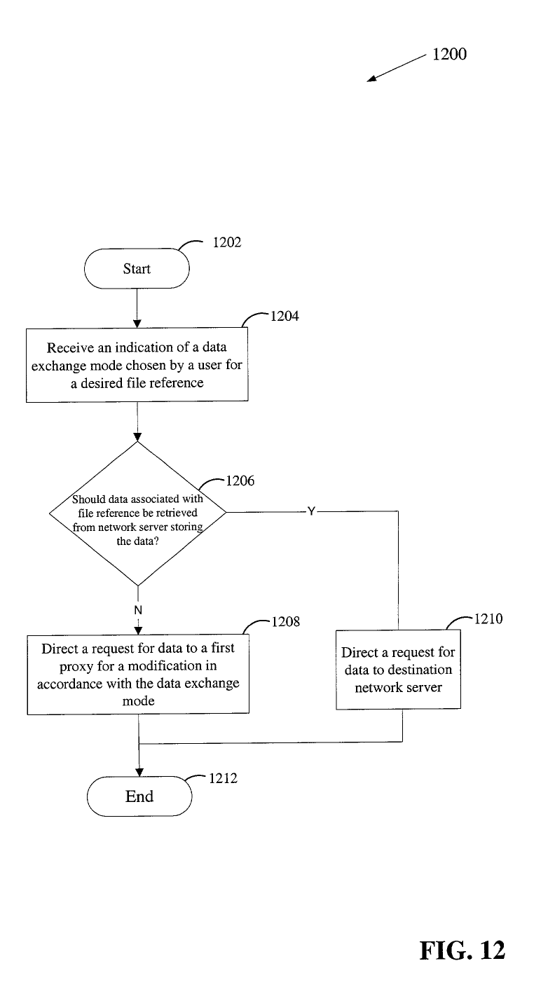

FIG. 12 is a flow diagram of a method 1200 for varying destination computers depending on data exchange modes of document retrieval requests, according to one embodiment of the present invention. Method 1200 begins with receiving an indication of a data exchange mode selected by a user for a specific file reference. As described above, the data exchange mode may be selected prior to identifying a specific file reference or after this identification.

At decision box 1206, a determination is made as to whether the document data associated with the file reference should be retrieved from a network server that stores this document data. The determination is made based on the data exchange mode selected by the user. In one embodiment, the determination depends on whether the selected exchange mode requires modification of either a document retrieval request or document data retrieved from the network server.

If the determination is positive (e.g., if no such modification is required), the document retrieval request is directed to the network server (processing block 1210). Otherwise, if the determination is negative (e.g., if either the document request or the document data must be filtered), then the document retrieval request is directed to a proxy server (processing block 1208). In one embodiment, when the proxy server receives the request, it modifies the request if required by the selected data exchange mode (e.g., removes the user-specifying information) and forwards the request to the network server. Further, when the network server sends a response with the requested data, the proxy server modifies the data if required by the selected data exchange mode (e.g., reduces the size of the data) and forwards the data to the client computer. In an alternative embodiment, the request and the retrieved data are passed through a chain of proxies servers to perform various modifications required by the data exchange mode, as will be described in more detail below.

FIG. 8 is a block diagram illustrating a coordination of destination computers for a document retrieval request based on a data exchange mode, according to one embodiment of the present invention. Referring to FIG. 8, if the user selects the “Trusted” data exchange mode after selecting a document on the computer screen, client computer 820 sends document request 800, containing the document location and cookie, directly to server 860. Server 860 then sends response 810, containing the requested document data, directly to client 820. If the user selects the “Protected & Brief” data exchange mode after selecting the same document on the computer screen, the document request 830, containing the document location and cookie, is sent to proxy server 840. Proxy server 840 removes cookie information from document request 830 and sends the modified request 850 to document server 860, which returns response 880 containing the document data and the “set-cookie” field. Proxy server 840 removes the “set-cookie” field, reduces the size of the document data and passes reduced data 870 to client 820. In this embodiment, proxy server 840 is used only when the user selects a data exchange mode that requires modification of the data stream, thereby decreasing the load of proxy server 840. An additional advantage of sending requests for the same document to different computers depending on a selected data exchange mode is that it makes an unauthorized accumulation of the browsing history more difficult.

In one embodiment, a client software application detects the selected data exchange mode and changes the address of the proxy server used by the browser. After the retrieval request for the current document is sent, the client software restores prior proxy settings. Accordingly the selected data exchange mode affects only this retrieval request. In another embodiment, the client software inserts the location of the proxy, which supports the current data exchange mode, before the location of the requested document. Subsequently, the proxy server extracts the document location and forwards it to the document server.

In the embodiment shown on FIG. 8, proxy server 840 does not receive information identifying the selected data exchange mode. Upon receiving the document request, this proxy server performs a fixed set of operations involving, for example, removing the user-specific information from the document request and reducing the size of the received document data. Upon detecting a selection of a different data exchange mode, the data request may be sent to a different proxy server or a different program on the same proxy server. This use of different proxy servers for different data exchange modes allows different filtering services to support highly optimized but limited sets of filtering operations while being easily available during every document request.

In another embodiment of the present invention, document retrieval requests may be passed through more than one proxy server depending on a selected data exchange mode. An example of this embodiment is shown on FIG. 9.

Referring to FIG. 9, if a selected data exchange mode is “Protected”, client 900 sends document request 950 with an identifier of the selected data exchange mode to first proxy 910. First proxy server 910 then removes the user-specific information and passes document request 955 to document server 930. Server 930 sends response 965 with document data and the “set-cookie” field to first proxy 910, which removes the “set-cookie” field and sends document data 960 to client 900.

If the selected data exchange mode is “Protected & Brief”, client 900 sends document request 905 to the same proxy server 910, but with an identifier of the “Protected & Brief” data exchange mode. If proxy server 910 is capable of providing both privacy protection and document reduction, it can send document data to server 930 after removing user-specific information and then reduce the size of received document data before passing it to client 900. Alternatively, proxy server 910 sends the document request to one or more other proxy servers depending on the selected data exchange mode. In the example shown on FIG. 9, first proxy server 910 is capable of protecting privacy of the user (by, for example, removing user-specific information from the document request and removing the “set-cookie” field from the response) but is not capable of reducing the size of received document data. Accordingly, when the “Protected” data exchange mode is selected, first proxy server 910 communicates directly with document server 930. However, when the “Protected & Brief” mode is selected, first proxy server 910 removes user-specific information and passes document request to second proxy server 920 that supports document reduction. Proxy server 920 passes document request 925 to server 930, which responds with a message 945 containing document data and the “set-cookie” field. Proxy 920 performs document size reduction and sends message 940 with the reduced document data and the “set-cookie” field to first proxy server 910. At this stage, the “set-cookie” field is not removed from the message because second proxy server 920 is unaware that the user requested privacy protection and may not be capable of privacy-enhancing processing. Removal of the “set-cookie” field is done by first proxy server 910 which sends message 935 with the reduced document data back to client 900. In this embodiment of the present invention, data filtering operations are performed by various chains of proxy servers, depending on a selected data exchange mode. In one embodiment, an identifier of a selected data exchange mode can be propagated to one or more proxy servers in each chain; each proxy server that receives document requests in different data exchange modes with corresponding identifiers may direct such requests to different computers. In one embodiment, an identifier of the data exchange mode is modified by each proxy in the chain to indicate that the next proxy in the chain does not need to perform all the operations that were required by the data exchange mode selected by the user. Alternatively, some proxies in the chain are pre-configured to perform a certain set of operations. Such proxies receive requests without identifiers of data exchange modes.

Thus, data is modified in a flexible network of proxy servers, re-configurable for different data exchange modes. As a result, the current competition between different proxy services as unique connection points between user computers and document servers can be augmented by the collaboration of these proxy services in providing a wide variety of services to the same user.

Embodiments of the present invention illustrated by the FIGS. 8 and 9 can also be used together, when document requests in the different data exchange modes are sent from the client computer to different computers in the network, while some of these computers, in their turn, pass document requests to other computers performing different filtering services.

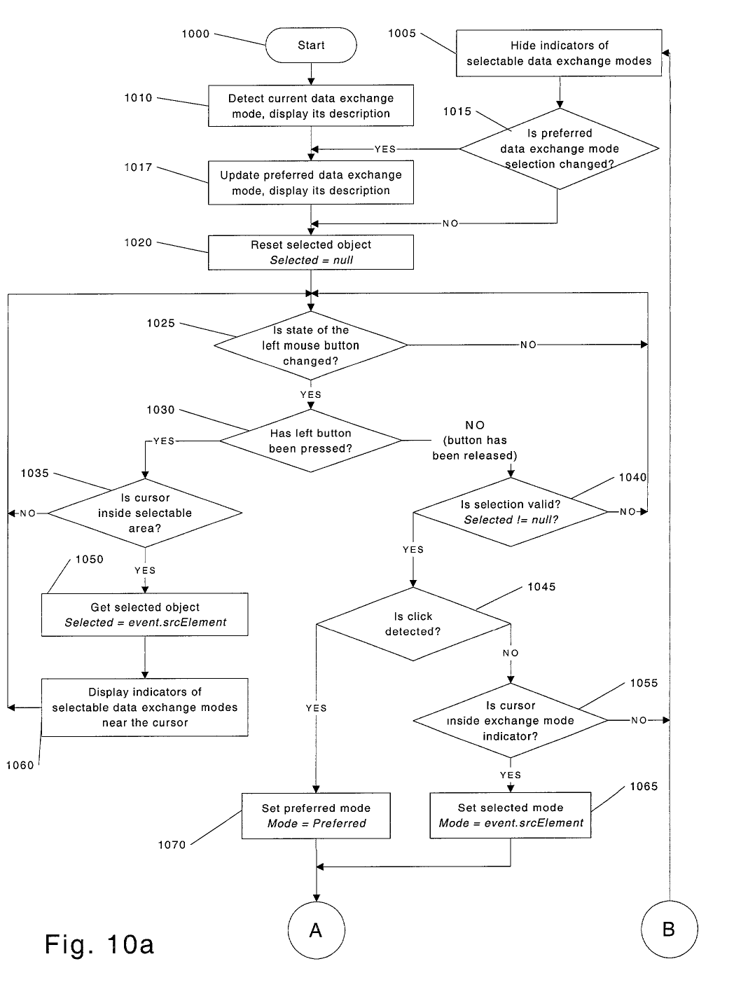

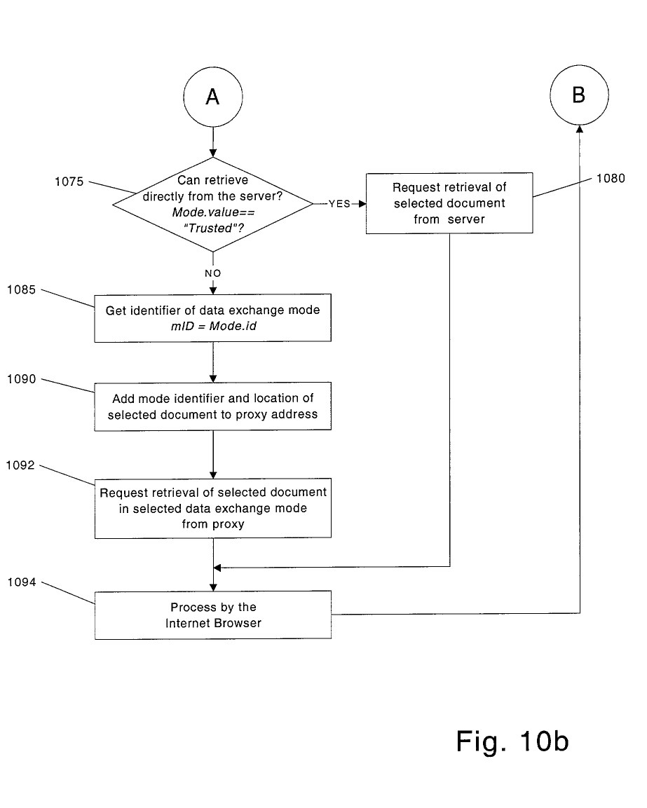

FIGS. 10A and 10B comprise a flowchart of a method for retrieving a document in a computer network, according to one embodiment of the present invention.

At processing block 1010, a data exchange mode used to retrieve a current document is detected and the description of this data exchange mode is displayed. Detection of the current data exchange mode is performed, for instance, by analyzing an identifier of the data exchange mode incorporated into the document address as described above. At processing block 1010, a preferred data exchange mode is updated and its description is displayed. This update occurs after loading a new document. In addition, at processing block 1015, a check is performed to determine whether or not a new preferred data exchange mode is selected by the user. If a new preferred data exchange mode is selected, it is updated by processing block 1017. Otherwise, processing block 1010 is bypassed. Before any document is selected for retrieval, the variable Selected is initialized by processing block 1020.

At decision box 1025, a determination is made as to whether the state of the left mouse button has changed. If this state has changed, then the left mouse button either became pressed or released. Decision box 1030 determines whether the left button has been pressed. If the left button has been pressed, decision box 1035 further determines whether the cursor is inside a selectable area associated with a document. For instance, the area is selectable if it is associated with a hyperlink Anchor having “A” tag and “HREF” attribute according to the HTML protocol.

If the area is selectable, processing block 1050 obtains a pointer to a selected object (e.g., by obtaining JScript property event.srcElement). After the left mouse button is pressed in the area associated with the selected document, processing block 1060 displays indicators of selectable data exchange modes near the cursor and returns control to decision box 1025, waiting for the release of the left mouse button. When the left mouse button is released, processing block 1025 invokes decision box 1030, which then invokes decision box 1040. Decision box 1040 makes a determination as to whether a valid document was selected when the left mouse button was pressed. If the determination is positive, decision box 1045 checks whether or not the left button release is a part of a mouse click, occurring, for example, when the mouse button is released at the same location where it was pressed.

If the mouse click is detected, processing block 1070 sets the preferred data exchange mode as a data exchange mode for the current document. If the mouse click is not detected, decision box 1055 checks whether or not the cursor is inside one of the indicators of the selectable data exchange modes displayed by processing block 1060. If the cursor is inside such an indicator, processing block 1065 sets the selected data exchange mode as a data exchange mode for the current document (e.g., by obtaining JScript property event.srcElement associated with selected indicator).

Next, processing block 1075 obtains the identifier of the data exchange mode selected by one of processing blocks 1065 or 1070 and determines whether the selected document can be retrieved directly from the server. If the determination is positive, processing block 1080 requests retrieval of the selected document from the server. Otherwise, processing block 1085 obtains an identifier of the selected mode and passes it to processing block 1090 which forms the document request directed to the proxy by adding the data exchange mode identifier and the document location to the proxy address. One example of a resulting document request is shown on FIG. 3A in field 302, which displays a request string used for a currently displayed document that was retrieved in the “Protected” mode. Alternatively, the exchange mode identifier and/or the document location can be sent to the proxy server in other parts of the document request message, for instance, as parameters of the POST method.

After the document request message is formed, processing block 1092 issues a request to retrieve a document, which is processed by the browser in processing block 1094.

### Computer Architecture

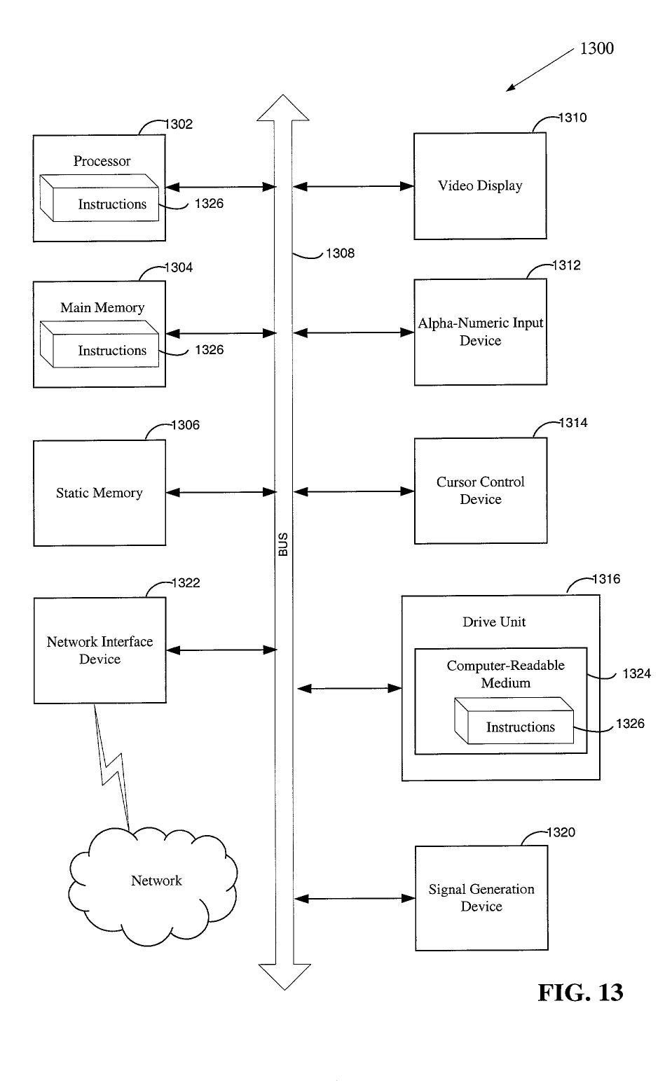

FIG. 13 shows a diagrammatic representation of machine in the exemplary form of a computer system 1300 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1300 includes a processor 1302, a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alpha-numeric input device 1312 (e.g., a keyboard), a cursor control device 1314 (e.g.,a mouse), a disk drive unit 1316, a signal generation device 1320 (e.g., a speaker) and a network interface device 1322.

The disk drive unit 1316 includes a computer-readable medium 1324 on which is stored a set of instructions (i.e., software) 1326 embodying any one, or all, of the methodologies described above. The software 1326 is also shown to reside, completely or at least partially, within the main memory 1304 and/or within the processor 1302. The software 1326 may further be transmitted or received via the network interface device 1322. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to included, but not be limited to, solid-state memories, optical and magnetic disks, and carrier wave signals.

Thus, methods and systems for retrieving documents in a computer network have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method for retrieving documents in a computer network, the method comprising:
receiving an indication of a document selection performed by a user, the document selection identifying a desired file reference contained within a document displayed to the user;
in response to receiving the indication of the document selection, displaying to the user a list of one or more selectable data exchange modes;
determining a data exchange mode selected by the user for the desired file reference; and
ensuring that a request to retrieve data associated with the desired file reference from a server is in accordance with the selected data exchange mode.

2. The method of claim 1 wherein said ensuring further comprises:
modifying one or more configuration parameters of an Internet browser in accordance with the selected data exchange mode; and
restoring the one or more configuration parameters of the Internet browser upon processing the request for data associated with the desired file reference.

3. The method of claim 1 wherein said ensuring further comprises:
modifying the request issued by an Internet browser in accordance with the data exchange mode selected by the user.

4. The method of claim 1 further comprising:
in response to receiving the indication of the document selection, associating a previously identified preferred data exchange mode with the desired file reference unless detecting that the user has performed an action sequence indicating a user selection of a data exchange mode other than the previously identified preferred data exchange mode.

5. The method of claim 4 wherein the action sequence indicating the user selection of the data exchange mode other than the preferred data exchange mode includes a user interaction with any one of a cursor control device and a keyboard key.

6. The method of claim 1 wherein the user selection of the data exchange mode affects only the data associated with the desired file reference.

7. The method of claim 1 wherein the selected data exchange mode affects any one of the amount of user-specific information sent with the request, the amount of data sent by the server in response to the request, and the format of data sent by the server in response to the request.

8. The method of claim 1 wherein the server is a network server storing the data associated with the desired file reference.

9. The method of claim 1 wherein:
the server is a proxy that communicates with a network server storing the data associated with the desired file reference; and
said ensuring further comprises the proxy modifying the request for data when required by the selected data exchange mode, and the proxy modifying data received from the network server when required by the selected data exchange mode.

10. The method of claim 9 wherein the request for data sent to the proxy contains an identifier of the selected data exchange mode.

11. The method of claim 1 wherein said ensuring further comprises:
sending a request to retrieve data associated with the desired file reference to a first server, the request conforming to the selected date exchange mode;
receiving a response from the first server, the response indicating a new location of the data associated with the desired file reference; and
automatically issuing a second request to a second server using the new location, the second request conforming to the selected data exchange mode.

12. The method of claim 1 wherein:
data associated with the desired file reference is stored on a plurality of servers; and
said ensuring further comprises sending a request to each of the plurality of servers, the request conforming to the selected date exchange mode.

13. The method of claim 1 wherein said ensuring further comprises:
including an identifier of the selected data exchange mode; and
sending the request with the identifier of the selected data exchange mode to a first proxy.

14. The method of claim 13 further comprising:
the first proxy selecting a second proxy as a recipient of the request based on the identifier of the selected data exchange mode and a predefined set of operations performed by the second proxy.

15. The method of claim 13 further comprising:
the first proxy taking responsibility for performing a first portion of operations required by the selected data exchange mode; and
the first proxy selecting a second proxy for performing a second portion of operations required by the selected data exchange mode.

16. The method of claim 15 further comprising:
the first proxy updating the identifier of the data exchange mode with an identifier value associated with the second portion of operations; and
the first proxy sending the request with the updated identifier value to the second proxy.

17. A method for retrieving documents in a computer network, the method comprising:
receiving an indication of a data exchange mode chosen by a user for a desired file reference;
determining, based on the data exchange mode, whether data associated with the desired file reference should be retrieved directly from a destination network server storing the data; and
when the data should not be retrieved directly from the destination server, directing a request for data to a proxy for a modification in accordance with the data exchange mode.

18. The method of claim 17 wherein the modification in accordance with the data exchange mode affects any one of the amount of user-specific information sent with the request, the amount of data sent by the server in response to the request, and the format of data sent by the server in response to the request

19. The method of claim 17 wherein the data should not be retrieved directly from the destination server if the data exchange mode requires modifying either the request for data or the data retrieved from the destination server.

20. The method of claim 17 further comprising:
the proxy sending the request to the destination network server, the request conforming to the data exchange mode;
the proxy receiving the data associated with the desired file reference from the destination computer; and
the proxy modifying the data when required by the data exchange mode.

21. The method of claim 17 wherein directing the request for data to the proxy further comprises:
identifying one of a plurality of proxies as a recipient of the request; and
sending the request to said one of the plurality of proxies.

22. The method of claim 21 wherein:
at least one of the plurality of proxies performs a predefined set of operations; and
said identifying is based on the predefined set of operations and the data exchange mode.

23. The method of claim 17 further comprising:
adding additional information to the request sent to at least one of the plurality of proxies, the additional information including an identifier of the data exchange mode.

24. A system for retrieving documents in a computer network, the system comprising:
a data exchange mode identifier to receive an indication of a document selection performed by a user, the document selection identifying a desired file reference contained within a document displayed to the user, and to determine a data exchange mode selected by the user for the desired file reference; and
a request modifier to ensure that a request to retrieve data associated with the desired file reference from a server is in accordance with the selected data exchange mode.

25. The system of claim 24 wherein determination of the data exchange mode remains valid only for the data associated with the desired file reference, and is updated after receiving indication of the next document selection by the user.

26. A system for retrieving documents in a computer network, the system comprising:
a data exchange mode identifier to receive an indication of a data exchange mode chosen by a user for a desired file reference; and
a destination coordinator to determine, based on the data exchange mode, whether data associated with the desired file reference should be retrieved directly from a destination network server storing the data, and to direct a request for data to a proxy when the data should not be retrieved directly from the destination server.

27. The system of claim 26 wherein data exchange mode used by the destination coordinator remains valid only for the data associated with the desired file reference, and is updated for the next desired file reference.

28. A computer readable medium that provides instructions, which when executed on a processor, cause said processor to perform operations comprising:
receiving an indication of a document selection performed by a user, the document selection identifying a desired file reference contained within a document displayed to the user;
in response to receiving the indication of the document selection, displaying to the user a list of one or more selectable data exchange modes;
determining a data exchange mode selected by the user for the desired file reference; and
ensuring that a request to retrieve data associated with the desired file reference from a server is in accordance with the selected data exchange mode.

29. A computer readable medium that provides instructions, which when executed on a processor, cause said processor to perform operations comprising:
receiving an indication of a data exchange mode chosen by a user for a desired file reference;
determining, based on the data exchange mode, whether data associated with the desired file reference should be retrieved directly from a destination network server storing the data; and
when the data should not be retrieved directly from the destination server, directing a request for data to a proxy for a modification in accordance with the data exchange mode.
